(19) United States
(12) Patent Application Publication
(10) Pub. No.: US 2016/0148068 A1
(43) Pub. Date: May 26, 2016

(54) IMAGE PROCESSING APPARATUS AND METHOD, AND ELECTRONIC DEVICE

(71) Applicant: Sony Corporation, Tokyo (JP)

(72) Inventors: Gang XU, Beijing (CN); FuTao HE, Beijing (CN); Yuejie TAN, Beijing (CN); Qing YANG, Beijing (CN)

(21) Appl. No.: 14/439,953

(22) PCT Filed: Mar. 4, 2015
(86) PCT No.: PCT/IB2015/051570

§ 371 Date: Apr. 30, 2015

(30) Foreign Application Priority Data
Aug. 15, 2014 (CN) 201410403771.5

(51) Int. Cl. G06K 9/46; G06T 3/40; H04N 5/232; G06K 9/00

(52) U.S. Cl. CPC G06K 9/46; G06K 9/00255; G06K 9/00268; G06T 3/4038; H04N 5/23212

(57) ABSTRACT

Embodiments of the present disclosure provide an image processing apparatus and method, and an electronic device, wherein the apparatus includes: an image acquiring unit configured to acquire an image shot in real-time; a detecting unit configured to detect an object needing a fuzzy processing and/or a part thereof in the image shot in real-time; and a processing unit configured to perform a fuzzy processing of the detected object and/or a part thereof. The object needing a fuzzy processing and/or a part thereof is automatically detected in the shooting process to perform corresponding fuzzy processing, rather than recording the shot image in advance, reproducing the recorded image and searching therein, and finally performing a fuzzy processing. Thus the present disclosure can increase the efficiency of the fuzzy processing, improve the accuracy and integrity of the processing result, and reduce the risk of secrete divulgation caused by omission or error processing.

### TECHNICAL FIELD

The present disclosure relates to the field of information technologies, and particularly, to an image processing apparatus and method, and an electronic device.

### CROSS REFERENCE TO RELATED APPLICATIONS

Priority is claimed from Chinese patent application No. 201410403771.5, filed Aug. 15, 2014, the entire disclosure of which hereby is incorporated by reference.

### BACKGROUND ART

Currently, with the continuous development of information technologies, the public obtain more and more information from the media. However, when a photograph or video is published or played in the media, such as network, television or newspaper, sometimes a fuzzy processing should be performed for certain contents in the photograph or video to protect an individual's privacy. For example, when a news photograph or video is related to crimes, a fuzzy processing would be performed for the face of a witness or adolescent appearing therein. The existing processing method is to perform a fuzzy processing of the portion to be processed in the image after shooting and recording the photograph or video.

### SUMMARY

Currently, when a fuzzy processing of an image is to be performed, firstly the image to be processed, which has been shot and stored in the storage medium, is searched for and reproduced; then related personnel search for a portion to be processed in the displayed image and perform corresponding processing of the found portion. Thus, the existing processing method needs to shoot, record and reproduce the image, manually search for the image to be processed, and detect a portion needing fuzzy processing in the found image. Thus, the workload is large and the efficiency is low. In addition, mistakes or omissions may easily occur during the processing.

As an example, information that is desired to remain secret, confidential, etc., e.g., the image of a face or some other information, examples of which are described herein, can be maintained private in a real time record without relying on post-production of an image, such as a photograph or video. Various techniques for fuzzy processing may be used to maintain privacy; some examples being applying a mosaic pattern over part or all of the image, blocking out part or all of an image, making out of focus part or all of an image, and so on. The possibility of leaking privacy or confidential or secret information is reduced or avoided because the fuzzy process is conducted in the real time record rather than in post-production of the image.

Embodiments of the present disclosure provide an image processing apparatus and method, and an electronic device. The object needing a fuzzy processing and/or a part thereof is automatically detected in the shooting process to perform corresponding fuzzy processing, rather than recording the shot image in advance, reproducing the recorded image and searching therein, and finally performing a fuzzy processing. Thus, the present disclosure can increase the efficiency of the fuzzy processing, improve the accuracy and integrity of the processing result, and reduce the risk of secrete divulgation (e.g., the risk of divulging that which should be concealed, hidden or secret) caused by omission or error processing.

According to a first aspect of embodiments of the present disclosure, an image processing apparatus is provided, wherein the apparatus includes: an image acquiring unit configured to acquire an image shot in real-time; a detecting unit configured to detect an object needing a fuzzy processing and/or a part thereof in the image shot in real-time; and a processing unit configured to perform a fuzzy processing of the detected object and/or a part thereof.

According to a second aspect of embodiments of the present disclosure, an electronic device is provided, wherein the electronic device includes the image processing apparatus according to the first aspect of the embodiments of the present disclosure.

According to a third aspect of embodiments of the present disclosure, an image processing method is provided, including: acquiring an image shot in real-time; detecting an object needing a fuzzy processing and/or a part thereof in the image shot in real-time; and performing a fuzzy processing of the detected object and/or a part thereof.

Embodiments of the present disclosure have following beneficial effect: the object needing a fuzzy processing and/or a part thereof is automatically detected in the shooting process to perform corresponding fuzzy processing, rather than recording the shot image in advance, reproducing the recorded image and searching therein, and finally performing a fuzzy processing. Thus, the present disclosure can increase the efficiency of the fuzzy processing, improve the accuracy and integrity of the processing result, and reduce the risk of secrete divulgation caused by omission or error in processing.

The following descriptions and drawings detailedly disclose specific embodiments of the present disclosure to indicate some ways for implementing principles of the present disclosure. It shall be appreciated that the range of embodiments of the present disclosure is not limited thereto. Embodiments of the present disclosure include many changes, modifications and equivalents falling within the range of the spirit and clauses of the accompanying claims.

Feature information described and illustrated with respect to one embodiment can be used in one or more other embodiments in a same or similar way, be combined with or replace feature information in other embodiments.

To be emphasized, the term ‘comprise/include’ used herein specifies the presence of feature information, assembly, step or component, not excluding the presence or addition of one or more other feature information, assemblies, steps or components.

### BRIEF DESCRIPTION OF DRAWINGS

Many aspects of the present disclosure will be understood better with reference to the following drawings. The components in the drawings are not necessarily drafted in proportion, but are for illustrating principles of the present disclosure. For the convenience of illustrating and describing some portions of the present disclosure, corresponding portions in the drawings may be zoomed in or out. The elements and feature information illustrated in one drawing or embodiment of the present disclosure may be combined with the elements and feature information illustrated in one or more other drawings or embodiments. In addition, similar reference signs denote corresponding parts in several drawings, and can be used to denote corresponding parts in more than one embodiment.

In the drawings:

FIG. 1 is a structural diagram of an image processing apparatus in Embodiment 1 of the present disclosure;

FIG. 2 is a structural diagram of a feature information acquiring unit 105 in Embodiment 1 of the present disclosure;

FIG. 3 is a schematic diagram of shooting an object needing a fuzzy processing and/or a part thereof in Embodiment 1 of the present disclosure;

FIG. 4 is a schematic diagram of selecting information related to an object needing a fuzzy processing and/or a part thereof from a database in Embodiment 1 of the present disclosure;

FIG. 5 is a schematic diagram of performing an image processing with an image processing apparatus 100 in Embodiment 1 of the present disclosure;

FIG. 6 is a block diagram of a system construction of an electronic device in Embodiment 2 of the present disclosure; and

FIG. 7 is a flowchart of an image processing method in Embodiment 3 of the present disclosure.

### DESCRIPTION OF EMBODIMENTS

The interchangeable terms ‘electronic device’ and ‘electronic apparatus’ include a portable radio communication device. The term ‘portable radio communication device’, which is hereinafter referred to as ‘mobile radio terminal’, ‘portable electronic apparatus’, or ‘portable communication apparatus’, include all devices such as mobile phone, pager, communication apparatus, electronic organizer, personal digital assistant (PDA), smart phone, portable communication apparatus, etc.

In the present application, embodiments of the present disclosure are mainly described with respect to a portable electronic apparatus in the form of a mobile phone (also referred to as ‘cellular phone’). However, it shall be appreciated that the present disclosure is not limited to the case of the mobile phone and it may relate to any type of appropriate electronic device, such as photo camera, video camera, tablet PC, smart watch, smart glasses, head-mounted device, wearable device, fixed-line telephone, media player, gaming device, PDA and computer, etc.

The preferred embodiments of the present disclosure are described as follows with reference to the drawings.

### Embodiment 1

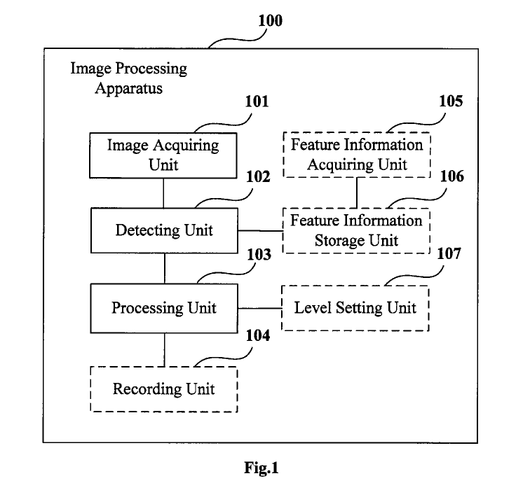

Embodiments of the present disclosure provide an image processing apparatus, and FIG. 1 is a structural diagram of an image processing apparatus in Embodiment 1 of the present disclosure. As illustrated in FIG. 1, the image processing apparatus 100 includes: an image acquiring unit 101, a detecting unit 102 and a processing unit 103, wherein,

The image acquiring unit 101 is configured to acquire an image shot in real-time. The detecting unit 102 is configured to detect an object needing a fuzzy processing and/or a part thereof in the image shot in real-time. The processing unit 103 is configured to perform a fuzzy processing of the detected object and/or a part thereof.

As can be seen from the embodiment, the object needing a fuzzy processing and/or a part thereof is automatically detected in the shooting process to perform corresponding fuzzy processing, rather than recording the shot image in advance, reproducing the recorded image and searching therein, and finally performing a fuzzy processing. Thus, the present disclosure can increase the efficiency of the fuzzy processing, improve the accuracy and integrity of the processing result, and reduce the risk of secrete divulgation caused by omission or error processing.

In this embodiment, the image processing apparatus 100 may further includes a recording unit 104. The recording unit 104 is configured to record an image that has gone through the fuzzy processing.

Thus, the image processing apparatus 100 is capable of recording the image gone through the fuzzy processing at the same time of shooting, so as to directly use the image gone through the fuzzy processing when necessary.

In this embodiment, the recording unit 104 is optional, and is illustrated with a dashed box in FIG. 1. That is to say, the image processing apparatus 100 may be provided with the recording unit 104 to record the image gone through the fuzzy processing; and the image processing apparatus 100 may also be not provided with the recording unit 104. Instead, the image that has gone through the fuzzy processing in the processing unit 103 is transmitted to other device for a storage, or directly stored into an external memory.

In this embodiment, the operation of the image processing apparatus 100 may be started up or shut down manually or automatically according to the actual demand, e.g., demand, preference or requirements of the user, or different applications.

For example, when shooting a photograph or video requiring privacy protection, the user may manually start up the operation of the image processing apparatus 100, and when shooting his personal photograph or video, the user may manually shut down the operation of the image processing apparatus 100.

For example, when a widely open social software is to be operated, the operation of the image processing apparatus 100 may be started up automatically according to the application, e.g., the application or software operated in or by the electronic device, and when a communication software just open to relatives and friends is to be operated, the operation of the image processing apparatus 100 may be shut down automatically according to the application.

In this embodiment, the image shot in real-time may be any type of the existing images, such as a static photograph or a continuous video, which is not limited herein.

In this embodiment, the image acquiring unit 101 may acquire the image shot in real-time using any of the exiting methods. For example, the image acquiring unit 101 may be a shooting unit that includes elements such as imaging lens and image sensor, so as to directly acquire the image shot in real-time, or it may use other apparatus or part for a shooting in real-time and then acquire the image shot in real-time from the apparatus or part.

In this embodiment, after the image shot in real-time is acquired, the detecting unit 102 detects the object needing a fuzzy processing and/or a part thereof in the image shot in real-time.

In this embodiment and, as will become apparent with respect to at least some of the other embodiments, the fuzzy processing means fuzzifying, e.g., making fuzzy, out of focus, or the like and/or otherwise adjusting or operating on the object and/or a part thereof in the image, so as to entirely or partially hide or eliminate the information of the object and/or a part thereof.

In this embodiment, the processing unit 103 performs a fuzzy processing of the object and/or a part thereof. Thus, the personal security and secrete (e.g., information that should be concealed, hidden or secret) can be protected, and other requirements of the user can also be met.

For example, a fuzzy processing may be performed for an object such as the whole human body, a car license and the digit (e.g., an alphanumeric, number or the like), or a part of the object such as the face, so as to protect the personal security and secrete. For another example, the user hopes to perform a fuzzy processing of an object having a predetermined feature in the photograph or video, such as a red object. In embodiments of the present disclosure, it is unnecessary to specifically define the object going through the fuzzy processing.

In this embodiment, the fuzzy processing is needed by the object and/or a part thereof, wherein the fuzzy processing may be needed by just one or more objects, or just a part of one or more objects, or one or more objects and a part of other object. For example, the object needing the fuzzy processing may include the car license and the face at the same time.

In this embodiment, the detecting unit 102 may perform a detection according to pre-acquired feature information of the object needing a fuzzy processing and/or a part thereof. In this embodiment, the feature information may include one or more of image, name, type, color, shape and size of the object and/or a part thereof.

For example, if the feature information is name, it includes ‘face’ (e.g., the face of a person); the feature information also may be ‘human body’, ‘car license’, ‘digit’, etc. When a fuzzy processing is to be performed for all faces in the image shot in real-time, the feature information is ‘face’; when a fuzzy processing is to be performed for a bank card account occurring in the image shot in real-time, the feature information is ‘digit’; when a fuzzy processing is to be performed for all red objects in the image shot in real-time, the feature information is ‘red’; and when a fuzzy processing is to be performed for all faces and red objects in the image shot in real-time, the feature information is ‘face’ and ‘red’.

In this embodiment, the image processing apparatus 100 may further include a feature information acquiring unit 105 and a feature information storage unit 106. The feature information acquiring unit 105 is configured to pre-acquire the feature information; and the feature information storage unit 106 is configured to store the acquired feature information.

Next, the structure of the feature information acquiring unit 105 in the embodiment and the method for acquiring the feature information will be exemplarily described.

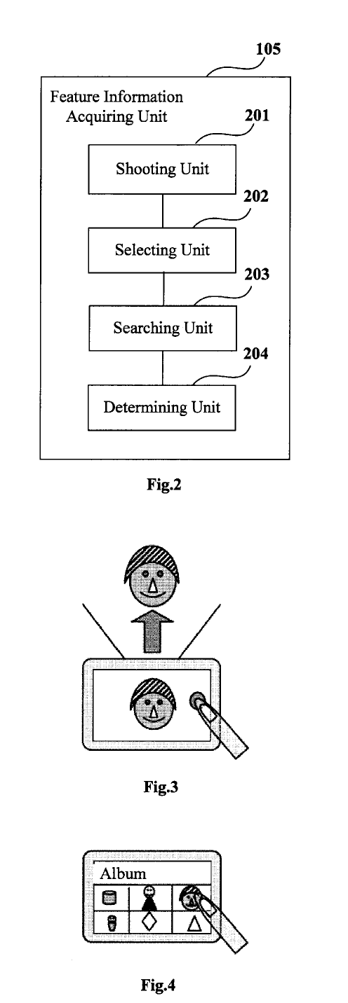

FIG. 2 is a structural diagram of a feature information acquiring unit 105 in this embodiment. As illustrated in FIG. 2, the feature information acquiring unit 105 includes a shooting unit 201, a selecting unit 202, a searching unit 203 and a determining unit 204. The shooting unit 201 is configured to shoot the object needing a fuzzy processing and/or a part thereof to acquire the feature information. The selecting unit 202 is configured to select information related to the object needing a fuzzy processing and/or a part thereof from a database to acquire the feature information. The searching unit 203 is configured to search in a network for information related to the object needing a fuzzy processing and/or a part thereof to acquire the feature information. The determining unit 204 is configured to predetermine a common attribute of the object needing a fuzzy processing and/or a part thereof to acquire the feature information.

In this embodiment, the feature information acquiring unit 105 may include one or more of the shooting unit 201, the selecting unit 202, the searching unit 203 and the determining unit 204 upon the actual demand of a user.

By providing the shooting unit 201, the selecting unit 202 or the searching unit 203, an accurate fuzzy processing may be performed for one or more specific objects and/or parts thereof; and by providing the determining unit 204 to detect based on the determined common attribute, the efficiency of the fuzzy processing can be further improved.

For example, for the purpose of protecting the personal security and secrete of the witness, when a photograph or video related to crimes is played, a fuzzy processing shall be performed for the witness or the face thereof. In that case, the witness's photograph of the whole body or the face may be pre-acquired through the shooting unit 201, the selecting unit 202 or the searching unit 203, so as to perform an automatic detection and a fuzzy processing based on the photograph of the whole body or the face during the shooting.

For example, when a fuzzy processing is to be performed for all faces in the image, the determining unit 204 may predetermine that the common attribute is the face; and when a fuzzy processing is to be performed for all red objects in the image, it may be predetermined that the common attribute is red.

In this embodiment, the shooting unit 201 may use any of the existing methods to shoot the object needing a fuzzy processing and/or a part thereof. FIG. 3 is a schematic diagram of shooting an object needing a fuzzy processing and/or a part thereof in this embodiment. As illustrated in FIG. 3, a face needing a fuzzy processing may be shot to acquire a photograph of the face needing a fuzzy processing.

In this embodiment, the database of the information related to the object needing a fuzzy processing and/or a part thereof used by the selecting unit 202 may be any of the existing databases, such as the local album, or the photo gallery, data bank, etc. in another application. The information related to the object needing a fuzzy processing and/or a part thereof may be any of the existing information, such as photograph, or feature information acquired using a statistical method in a certain application, such as feature information acquired by counting the usage habits or preferences of the users in the circle of friends of Wechat.

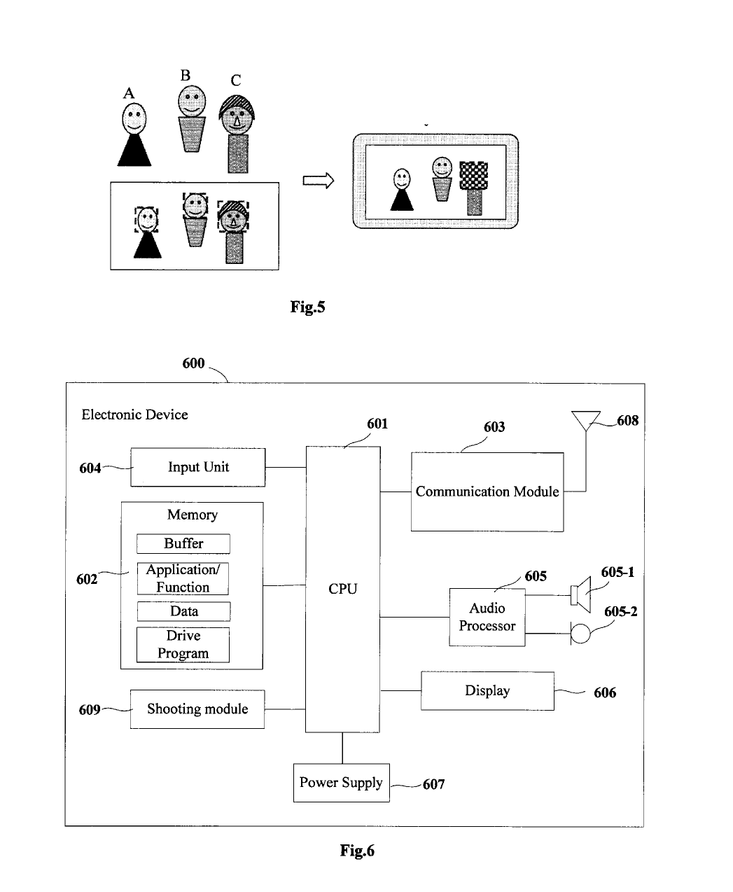

FIG. 4 is a schematic diagram of selecting information related to an object needing a fuzzy processing and/or a part thereof from a database in this embodiment. As illustrated in FIG. 4, the photograph of the face needing a fuzzy processing may be selected from an album, e.g., such as the album illustrated.

In this embodiment, the searching unit 203 may use any of the existing methods to search in a network for the information related to the object needing a fuzzy processing and/or a part thereof. For example, a link to a search engine is established, and the name of the object needing a fuzzy processing is entered, so as to find and download related image.

In this embodiment, the determining unit 204 may predetermine the common attribute of the object needing a fuzzy processing and/or a part thereof upon the actual demand. The common attribute may be the name, color, shape, etc. of the object and/or a part thereof. For example, the common attribute may be a human body, a face, a circle, red, etc.

In this embodiment, when the feature information of the object needing a fuzzy processing and/or a part thereof is pre-acquired, the detecting unit 102 may detect using an existing detection method.

For example, the local or overall features of the image of the face pre-acquired are extracted. When the local features are extracted, the face recognition may be performed through local template matching and/or gray projection. When the overall features are extracted, the face recognition may be performed through Eigen face, flexible matching, neural network or algebraic feature. The face needing a fuzzy processing is detected from all faces in the image shot in real-time based on the knowledge or statistical method.

For example, in a case where it is predetermined that the common attribute of the object needing a fuzzy processing and/or a part thereof is red, the red portion in the image shot in real-time can be detected using the existing method. For example, when a connected domain approaching the red pixels is larger than a set area, it is judged that a portion where the connected domain is located is the red portion in the image.

In this embodiment, after the detecting unit 102 detects the object needing a fuzzy processing and/or a part thereof, the processing unit 103 performs a fuzzy processing of the detected object and/or a part thereof in the process of the real-time shooting. In this embodiment any of existing methods can be used for the fuzzy processing, provided that the information of the object and/or a part thereof can be hidden or eliminated entirely or partially after the processing. For example, a mosaic pattern or a cartoon image can be displayed at the position of the detected object and/or a part thereof, so as to cover or replace the original information entirely or partially.

In this embodiment, when the images shot in real-time form a video, the detecting unit 102 and the processing unit 103 may perform a detection and a fuzzy processing of each frame of image in the video in a time sequence.

In this embodiment, the image processing apparatus 100 may further include a level setting unit 107, wherein the level setting unit 107 is configured to set a level of the fuzzy processing to be performed by the processing unit 103.

In this embodiment, the level setting unit 107 is an optional unit, and it is illustrated with a dashed box in FIG. 1.

In this embodiment, the level setting unit 107 sets the level of a fuzzy processing according to the actual demand e.g., the demand or requirements, etc. of the user, the feature information, the user right (e.g., the user's limit of authority or user's permission), the application or the usage occasion, e.g., when or where to use, and the processing unit 103 performs a fuzzy processing according to the set level.

In this embodiment, the fuzzy degree of the fuzzy processing increases with the level thereof, and more information of the object and/or a part thereof can be hidden after the fuzzy processing. When the level of the fuzzy processing is the highest, the information of the object and/or a part thereof is hidden entirely after the fuzzy processing. The fuzzy degree may be adjusted using an existing method. For example, the fuzzy degree may be adjusted by adjusting the color and/or density of mosaics at the position of the fuzzy processing.

For example, when the user hopes that the entire display effect is not influenced by an image gone through a fuzzy processing, the fuzzy processing may be set at a low level; when the user hopes that an object and/or feature information thereof of a fuzzy processing is private information such as ‘account’ (e.g., an account number or other account identifying information), the fuzzy processing may be set at a high level; and when a widely open software is to be run, the fuzzy processing may be set at a high level.

In this embodiment, the usage occasion may include usage location and/or time. For example, at a location where shooting is prohibited (e.g., a museum, a factory concerning know-how, etc.), the image processing apparatus 100 may be forcibly started to receive an instruction including the feature information of the object needing a fuzzy processing and/or a part thereof, and perform a detection and a fuzzy processing of the image shot in real-time according to the received feature information. In addition, the fuzzy processing may be set at a high level according to the requirement of the usage location.

FIG. 5 is a schematic diagram of performing an image processing with an image processing apparatus 100 in this embodiment. As illustrated in FIG. 5, the shot object includes three characters A, B and C, and the face of character C needs a fuzzy processing. Firstly, an image shot in real-time is acquired using the image acquiring unit 101. The detecting unit 102 detects all faces in the image shot in real-time to find the faces of characters A, B and C, illustrate them with a dashed box, and compare them with a pre-acquired face image of character C, so as to detect the face of character C from the shot preview image. The processing unit 103 displays a mosaic pattern on a position corresponding to the face of character C. The recording unit 104 may record the processed image to generate corresponding log file.

As can be seen from the embodiment, the object needing a fuzzy processing and/or a part thereof is automatically detected in the shooting process to perform corresponding fuzzy processing, rather than recording the shot image in advance, reproducing the recorded image and searching therein, and finally performing a fuzzy processing. Thus the present disclosure can increase the efficiency of the fuzzy processing, improve the accuracy and integrity of the processing result, and reduce the risk of secrete divulgation caused by omission or error processing.

### Embodiment 2

The embodiment of the present disclosure provides an electronic device. FIG. 6 is a block diagram of a system construction of an electronic device in this embodiment. As illustrated in FIG. 6, the electronic device 600 may include a central processing unit (CPU) 601 and a memory 602 coupled to the CPU 601. To be noted, the diagram is exemplary, and other type of structure may be used to supplement or replace the structure, so as to realize the telecom function or other function.

In one implementation, the functions of the image processing apparatus may be integrated into the CPU 601. In this implementation the CPU 601 may be configured to acquire an image shot in real-time; detect an object needing a fuzzy processing and/or a part thereof in the image shot in real-time; and perform a fuzzy processing of the detected object and/or a part thereof. The CPU 601 may be further configured to record the image gone through the fuzzy processing. Detecting the object needing a fuzzy processing and/or a part thereof in the image shot in real-time includes: detecting according to pre-acquired feature information of the object needing a fuzzy processing and/or a part thereof. The CPU 601 may be further configured to pre-acquire the feature information and to store the acquired feature information.

The pre-acquiring the feature information includes: shooting the object needing a fuzzy processing and/or a part thereof to acquire the feature information; and/or selecting information related to the object needing a fuzzy processing and/or a part thereof from a database to acquire the feature information; and/or searching in a network for information related to the object needing a fuzzy processing and/or a part thereof to acquire the feature information; and/or predetermining a common attribute of the object needing a fuzzy processing and/or a part thereof to acquire the feature information. The feature information includes one or more of image, name, type, color, shape and size of the object and/or a part thereof.

The CPU 601 may be further configured to set a level of the fuzzy processing. Setting a level of the fuzzy processing may include setting the level of the fuzzy processing according to the actual demand, the feature information of the object and/or a part thereof, the user right (e.g., the user's limits of authority or user's permission), the application or the usage occasion.

In another implementation, the image processing apparatus may be provided separately from the CPU 601. For example, the image processing apparatus may be provided as a chip connected to the CPU 601, and the functions of the image processing apparatus are realized under the control of the CPU.

As illustrated in FIG. 6, the electronic device 600 may include a communication module 603, an input unit 604, an audio processor 605, a speaker 605-1, a microphone 605-2, a display 606, a power supply 607, an antenna 608, and a shooting module 609. To be noted, the electronic device 600 is unnecessary to include all the parts as illustrated in FIG. 6. In addition, the electronic device 600 may also include parts not illustrated in FIG. 6, and please refer to the prior art.

As illustrated in FIG. 6, the CPU 601 sometimes is called as controller or operation control, and it may include a microprocessor or other processor device and logic device. The CPU 601 receives an input and controls the operations on respective parts of the electronic device 600.

In the embodiment(s), the memory 602 for example may be one or more of buffer, flash memory, hard drive, removable media, volatile memory, nonvolatile memory or other appropriate device. The memory 602 may store a program or software as well as data in the usual manner for operation of the electronic device. In addition, the CPU 601 may execute the program stored in the memory for information storage or processing. The functions of other parts are similar to those of the prior art, and herein are omitted. The parts of the electronic device 600 may be implemented with special hardware, firmware, software or combinations thereof, without deviating from the scope of the present disclosure.

As can be seen from the embodiment, the object needing a fuzzy processing and/or a part thereof is automatically detected in the shooting process to perform corresponding fuzzy processing, rather than recording the shot image in advance, reproducing the recorded image and searching therein, and finally performing a fuzzy processing. Thus the present disclosure can increase the efficiency of the fuzzy processing, improve the accuracy and integrity of the processing result, and reduce the risk of secrete divulgation caused by omission or error processing.

### Embodiment 3

The embodiment of the present disclosure further provides an image processing method. Since the method solves the problem using principles similar to the functions of the constituent parts of the image processing apparatus in Embodiment 1, the implementation of the method may refer to that of the image processing apparatus in Embodiment 1. The same contents are omitted herein.

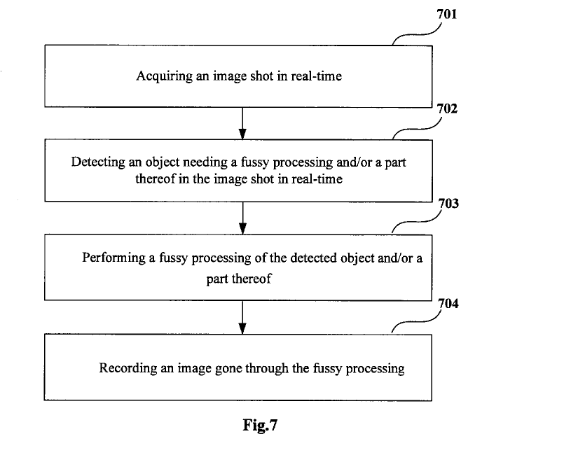

FIG. 7 is a flowchart of an image processing method in this embodiment. As illustrated in FIG. 7, the method includes:

Step 701: acquiring an image shot in real-time;

Step 702: detecting an object needing a fuzzy processing and/or a part thereof in the image shot in real-time;

Step 703: performing a fuzzy processing of the detected object and/or a part thereof; and

Step 704: recording an image gone through the fuzzy processing.

In this embodiment, step 704 is optional and is illustrated with a dashed box in FIG. 7.

In this embodiment, the method for acquiring an image shot in real-time, the method for detecting an object needing a fuzzy processing and/or a part thereof in the image shot in real-time, and the method for performing a fuzzy processing of the detected object and/or a part thereof, are the same as those described in Embodiment 1, and herein are omitted.

As can be seen from the embodiment, the object needing a fuzzy processing and/or a part thereof is automatically detected in the shooting process to perform corresponding fuzzy processing, rather than recording the shot image in advance, reproducing the recorded image and searching therein, and finally performing a fuzzy processing. Thus the present disclosure can increase the efficiency of the fuzzy processing, improve the accuracy and integrity of the processing result, and reduce the risk of secrete divulgation caused by omission or error processing.

The embodiment of the present disclosure further provides a computer readable program, which enables a computer to implement the image processing method of Embodiment 3 in an image processing apparatus or an electronic device, when the program is executed in the image processing apparatus or the electronic device.

The embodiment of the present disclosure further provides a storage medium storing a computer readable program which enables a computer to implement the image processing method of Embodiment 3 in an image processing apparatus or an electronic device.

The above apparatus and method of the present disclosure may be implemented by hardware, or a combination of hardware and software. The present disclosure relates to such a computer readable program that enables a logic part to implement the previously described apparatuses or constituent parts, or implement the previously described methods or steps, when the program is executed by the logic part.

The present disclosure also relates to a storage medium for storing the above program, e.g., hard disk, magnetic disk, optical disk, DVD and flash memory.

The present disclosure is described in conjunction with the above embodiments. But a person skilled in the art shall appreciate that the descriptions are just exemplary, rather than limitations to the protection scope of the present disclosure. A person skilled in the art can make various modifications and changes to the present disclosure under the spirit and principle of the present disclosure, and those modifications and changes also fall within the scope of the present disclosure.

1. An image processing apparatus, comprising:
an image acquiring unit configured to acquire an image shot in real-time;
a detecting unit configured to detect an object needing a fuzzy processing and/or a part thereof in the image shot in real-time; and
a processing unit configured to perform a fuzzy processing of the detected object and/or a part thereof.

2. The apparatus according to claim 1, further comprising:
a recording unit configured to record an image gone through the fuzzy processing.

3. The apparatus according to claim 1, wherein the detecting unit detects according to pre-acquired feature information of the object needing a fuzzy processing and/or a part thereof.

4. The apparatus according to claim 3, further comprising:
a feature information acquiring unit configured to pre-acquire the feature information;
a feature information storage unit configured to store the acquired feature information.

5. The apparatus according to claim 4, wherein the feature information acquiring unit comprises:
a shooting unit configured to shoot the object needing a fuzzy processing and/or a part thereof to acquire the feature information; and/or
a selecting unit configured to select information related to the object needing a fuzzy processing and/or a part thereof from a database to acquire the feature information; and/or
a searching unit configured to search in a network for information related to the object needing a fuzzy processing and/or a part thereof to acquire the feature information; and/or
a determining unit configured to predetermine a common attribute of the object needing a fuzzy processing and/or a part thereof to acquire the feature information.

6. The apparatus according to of claim 3, wherein the feature information comprises one or more of image, name, type, color, shape and size of the object and/or a part thereof.

7. The apparatus according to claim 1, further comprising:
a level setting unit configured to set a level of a fuzzy processing to be performed by the processing unit.

8. The apparatus according to claim 7, wherein,
the level setting unit sets the level of a fuzzy processing to be performed according to the actual demand, feature information of the object and/or a part thereof, a user right, an application or a usage occasion.

9. An electronic device, comprising the apparatus according to claim 1.

10. An image processing method, comprising:
acquiring an image shot in real-time;
detecting an object needing a fuzzy processing and/or a part thereof in the image shot in real-time; and
performing a fuzzy processing of the detected object and/or a part thereof.

11. The method according to claim 10, further comprising:
recording an image gone through the fuzzy processing.

12. The method according to claim 10, wherein detecting the object needing a fuzzy processing and/or a part thereof in the image shot in real-time comprises:
detecting according to pre-acquired feature information of the object needing a fuzzy processing and/or a part thereof.

13. The method according to claim 12, further comprising:
pre-acquiring the feature information; and
storing the acquired feature information.

14. The method according to claim 13, wherein pre-acquiring the feature information comprises:
shooting the object needing a fuzzy processing and/or a part thereof to acquire the feature information; and/or
selecting information related to the object needing a fuzzy processing and/or a part thereof from a database to acquire the feature information; and/or
searching in a network for information related to the object needing a fuzzy processing and/or a part thereof to acquire the feature information; and/or
predetermining a common attribute of the object needing a fuzzy processing and/or a part thereof to acquire the feature information.

15. The method according to claim 12, wherein the feature information comprises one or more of image, name, type, color, shape and size of the object and/or a part thereof.

16. The method according to claim 10, further comprising:
setting a level of the fuzzy processing to be performed.

17. The method according to claim 16, wherein setting a level of the fuzzy processing to be performed comprises:
setting the level of the fuzzy processing to be performed according to the actual demand, feature information of the object and/or a part thereof, a user right, an application or a usage occasion.

18. (canceled)

19. (canceled)

20. An image processing apparatus, comprising:
an image acquiring unit configured to acquire an image shot in real-time;
a detecting unit configured to detect an object needing a fuzzy processing and/or a part thereof in the image shot in real-time;
a processing unit configured to perform a fuzzy processing of the detected object and/or a part thereof; and
a recording unit configured to record an image gone through the fuzzy processing;
wherein the detecting unit detects according to pre-acquired feature information of the object needing a fuzzy processing and/or a part thereof; and
further comprising:
a feature information acquiring unit configured to pre-acquire the feature information;
a feature information storage unit configured to store the acquired feature information; and
wherein the feature information acquiring unit comprises:
a shooting unit configured to shoot the object needing a fuzzy processing and/or a part thereof to acquire the feature information; and/or
a selecting unit configured to select information related to the object needing a fuzzy processing and/or a part thereof from a database to acquire the feature information; and/or
a searching unit configured to search in a network for information related to the object needing a fuzzy processing and/or a part thereof to acquire the feature information; and/or
a determining unit configured to predetermine a common attribute of the object needing a fuzzy processing and/or a part thereof to acquire the feature information.
